(19) United States
(12) Patent Application Publication
(10) Pub. No.: US 2013/0054880 A1
(43) Pub. Date: Feb. 28, 2013

(54) SYSTEMS AND METHODS FOR REDUCING A NUMBER OF CLOSE OPERATIONS IN A FLASH MEMORY

(71) Applicants: Hung-Min CHANG, Hsinchu City (TW); Cheng-Fan LEE, Pingzhen City (TW); Po-Jen HSUEH, Kaohsiung City (TW)

(72) Inventors: Hung-Min CHANG, Hsinchu City (TW); Cheng-Fan LEE, Pingzhen City (TW); Po-Jen HSUEH, Kaohsiung City (TW)

(73) Assignee: STEC, Inc., Santa Ana, CA (US)

(21) Appl. No.: 13/588,664

(22) Filed: Aug. 17, 2012

Related U.S. Application Data
(60) Provisional application No. 61/527,913, filed on Aug. 26, 2011.

(51) Int. Cl. G06F 12/02

(52) U.S. Cl. 711/103; 711/E12.008

(57) ABSTRACT

The disclosed subject matter includes a memory system with a flash memory and a flash memory controller. The flash memory has a plurality of blocks, where each block is configured to store data. The flash memory controller is configured to maintain a queue having a plurality of slots, where each of the plurality of slots is configured to maintain an identifier of an open block in the flash memory. The controller is also configured to store data to a target block in the flash memory. Furthermore, the controller is configured to remove an identifier of one of the open blocks from the queue and to add an identifier of the target block to the queue.

### CROSS-REFERENCE TO RELATED APPLICATION

This application claims benefit under 35 U.S.C. §119(e) of U.S. Provisional Patent Application No. 61/527,913, entitled “SYSTEM AND METHOD OF REDUCING CLOSE OPERATIONS ON OPEN BLOCKS WHEN WRITING DATA TO A FLASH MEMORY,” filed on Aug. 26, 2011, which is expressly incorporated herein by reference in its entirety.

### FIELD OF THE DISCLOSURE

The present disclosure relates generally to the field of semiconductor non-volatile data storage system architectures and methods of operation thereof.

### BACKGROUND

A common application of flash memory devices may be as a mass data storage subsystem for electronic devices. Such subsystems may be commonly implemented as either removable memory cards that may be inserted into multiple host systems or as non-removable embedded storage within the host system. In both implementations, the subsystem may include one or more flash devices and often a flash memory controller.

Flash memory devices are composed of one or more arrays of transistor cells, with each cell capable of non-volatile storage of one or more bits of data. Accordingly, flash memory does not require power to retain data programmed therein. However, once programmed, a cell must be erased before it can be reprogrammed with a new data value. These arrays of cells are partitioned into groups to provide for efficient implementation of read, program and erase functions. A typical flash memory architecture for mass storage arranges large groups of cells into erasable blocks, wherein a block contains the smallest number of cells (or unit of erasure) that are erasable at one time.

Flash memory may be used generally to store computer files. A file system generally allows for organization of files by defining user-friendly abstractions including file names, file metadata, file security, and file hierarchies such as partitions, drives, folders, and directories. In flash memory, because a block may contain multiple cells, each block may store multiple data units.

Flash memory is different from other memory used for storage such as hard drives, because flash memory contains unique limitations. First, flash memory is limited in lifetime and exhibits memory wear that can deteriorate the integrity of the storage. Each erasable block or segment can be put through a limited number of re-write (“program”) and erase cycles before becoming unreliable. In many cases, the memory controller maintains a logical-to-physical block lookup table to translate the flash memory array physical block addresses to logical block addresses used by the host system. The controller uses wear-leveling algorithms to determine which physical block to use each time data is programmed, eliminating the relevance of the physical location of data on the flash memory array and enabling data to be stored anywhere within the flash memory array. Second, because of memory wear, traditional write operations to flash memory can take a comparatively long time due to leveling out potential wear on physical blocks. This is because a traditional write operation to a target logical block address (LBA) requires the flash memory to use a block-based algorithm to (1) use a program operation to write data to a new unused physical block, (2) update the logical-to-physical-block lookup table to point to the new physical block, and (3) erase the previous physical block associated with the LBA. These program/erase cycles in the flash memory can take a long time for each write operation requested by the host.

Ideally, writing data to the flash memory should be accommodated by tracking “open” and “closed” blocks and by updating a collection of open blocks that lessens the number of close operations that need to be performed.

### SUMMARY

Certain embodiments include a method for reducing a number of close operations in a flash memory. The method can include maintaining a queue having a plurality of slots, where each of the plurality of slots is configured to maintain an identifier of an open block in the flash memory. The method can also include receiving a request to write data to a target block, where the target block is one of a plurality of blocks in the flash memory, and determining if the queue includes an identifier of the target block. If the queue includes an identifier of the target block, the method can include storing the data at the target block of the flash memory. If the queue does not include the identifier of the target block, the method can include determining if each of the plurality of slots in the queue is associated with an open block, and if so, removing an identifier of one of the open blocks from the queue. If the queue does not include the identifier of the target block, the method can further include adding the identifier of the target block to the queue, and storing the data at the target block of the flash memory.

In any of the embodiments described herein, the identifier can include a memory address.

In any of the embodiments described herein, the method can further include maintaining a rear index and a front index for the queue, where the rear index references to a first slot and the front index references to a second slot, where the first slot is associated with the first open block to be removed from the queue, and where the second slot is associated with the last open block to be removed from the queue.

In any of the embodiments described herein, removing the identifier of one of the open blocks from the queue can include removing an identifier of the first open block in the first slot and modifying the rear index to reference a new first open block to be removed from the queue.

In any of the embodiments described herein, the method can include storing data of the one of the open blocks at another block in the flash memory.

In any of the embodiments described herein, the method can include, in response to storing the data of the one of the open blocks at another block in the flash memory, erasing the data in the one of the open blocks.

In any of the embodiments described herein, the flash memory can be configured with a New Technology File System (NTFS) file system.

Certain embodiments include a memory system. The memory system can include a flash memory having a plurality of blocks, where each block is configured to store data. The memory system can further include a flash memory controller configured to maintain a queue having a plurality of slots, where each of the plurality of slots is configured to maintain an identifier of an open block in the flash memory, to store data to a target block in the flash memory, and to remove an identifier of one of the open blocks from the queue and to add an identifier of the target block to the queue.

In any of the embodiments described herein, the identifier includes a memory address.

In any of the embodiments described herein, the controller can be configured to maintain a rear index and a front index for the queue, where the rear index references to a first slot and the front index references to a second slot, where the first slot is associated with the first open block to be removed from the queue, and where the second slot is associated with the last open block to be removed from the queue.

In any of the embodiments described herein, the controller can be further configured to remove an identifier of the first open block from the first slot and to modify the rear index to reference a new first open block to be removed from the queue.

In any of the embodiments described herein, the controller can be configured to store data in the one of the open blocks at another block in the flash memory.

In any of the embodiments described herein, the controller can be configured to erase the data in the one of the open blocks.

In any of the embodiments described herein, the flash memory can be configured with a New Technology File System (NTFS) file system.

In any of the embodiments described herein, the flash memory can be configured with a second extended file system (ext2), a third extended file system (ext3), or a fourth extended file system (ext4).

Certain embodiments include a non-transitory computer program product, tangibly embodied in a computer-readable medium. The computer program product can include instructions operable to cause a data processing apparatus to maintain a queue having a plurality of slots, where each of the plurality of slots is configured to maintain an identifier of an open block in the flash memory. The computer program product can also include instructions operable to cause the data processing apparatus to receive a request to write data to a target block, wherein the target block is one of a plurality of blocks in the flash memory, and to determine if the queue includes an identifier of the target block. If the queue includes the identifier of the target block, instructions in the computer program product can be operable to cause the data processing apparatus to store the data at the target block of the flash memory. If the queue does not include the identifier of the target block, instructions in the computer program product can be operable to cause the data processing apparatus to determine if each of the plurality of slots in the queue is associated with an open block, and if so, remove an identifier of one of the open blocks from the queue. If the queue does not include the identifier of the target block, instructions in the computer program product can also be operable to cause the data processing apparatus to add the identifier of the target block to the queue, and to store the data at the target block of the flash memory.

In any of the embodiments described herein, the identifier comprises a memory address.

In any of the embodiments described herein, the computer program product can include instructions operable to cause the data processing apparatus to maintain a rear index and a front index for the queue, where the rear index references to a first slot and the front index references to a second slot, where the first slot is associated with the first open block to be removed from the queue, and where the second slot is associated with the last open block to be removed from the queue.

In any of the embodiments described herein, the computer program product can include instructions operable to cause the data processing apparatus to remove an identifier of the first open block in the first slot and to modify the rear index to reference a new first open block to be removed from the queue.

In any of the embodiments described herein, the computer program product can include instructions operable to cause the data processing apparatus to erase data in the first open block.

### BRIEF DESCRIPTION OF THE DRAWINGS

FIG. 1 illustrates main hardware components of a flash memory system in accordance with certain embodiments;

FIGS. 2A-2B(i-vi) illustrate a single-sector algorithm for writing data to physical blocks in accordance with some embodiments;

FIG. 3 illustrates a flow diagram of a multi-section method of reducing the number of close operations on open blocks in accordance with certain embodiments;

FIGS. 4A-4C illustrate block diagrams of a system and multi-section method for reducing the number of close operations on open blocks in accordance with some embodiments; and

FIG. 5 illustrates a New Technology File System (NTFS) file system in accordance with some embodiments.

### DETAILED DESCRIPTION

The present disclosure relates to a system and method of reducing close operations on open blocks when writing data to a flash memory, resulting in faster write performance for the user. The system and method are implemented in the flash memory device. The present disclosure describes two methods of improving the block-based algorithm, (1) the single-sector algorithm and (2) the multi-section algorithm. As compared with the block-based algorithm, the present disclosure improves random write performance, and file-system-level applications which make single or multiple reads and writes of data.

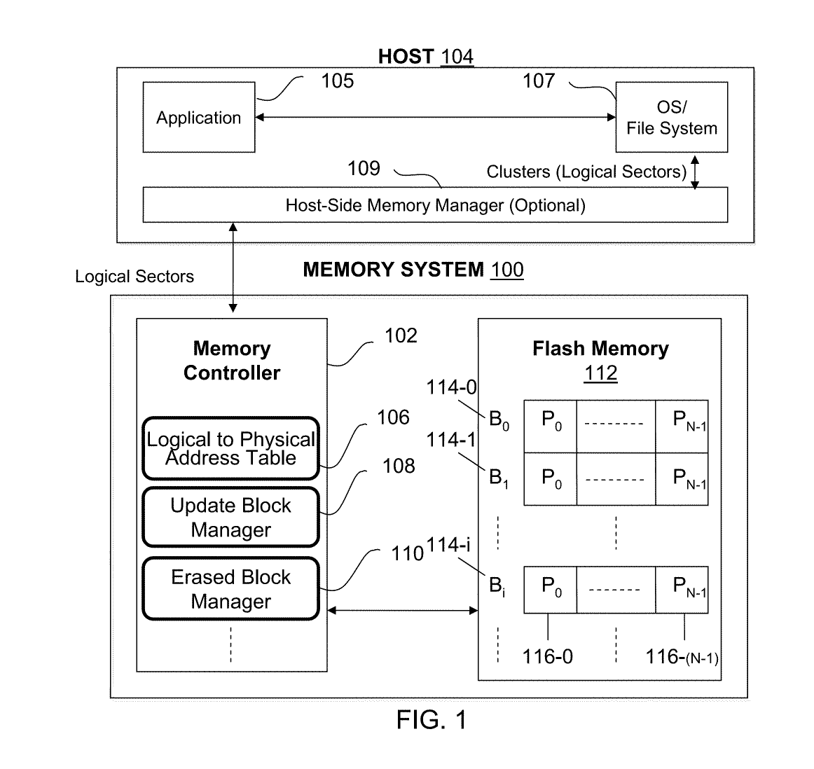

Turning now to the drawings, FIG. 1 illustrates main hardware components of a flash memory system in accordance with certain embodiments. FIG. 1 includes a memory system 100, a memory controller 102, a host 104, an update block manager 104, an erased block manager 110, and a flash memory array 112 having blocks B₀-Bᵢ 114 and pages P₀-P_{N-1} 116. The host 104 can include on or more applications 105 running on an operating system (OS) and its associated file system 107. The host can optionally include a host-side memory manager 109 to communicate with the memory system 100.

The memory system 100 includes a memory controller 102 and a flash memory 112. The memory controller 102 uses the logical-to-physical address table 106, the update block manager 108, and the erased block manager 110 to manage a flash memory array 112 of physical blocks B₀-Bᵢ 114. As described earlier, each block 114 may contain multiple data units. To refer to smaller units of data stored in blocks 114, the memory controller 102 may use pages, offsets, sectors, or clusters (not shown). The host 104 interacts with the flash memory system 100 using logical block addresses (LBA), which the logical-to-physical address table 106 translates into physical block addresses. The memory controller 102 is also able to track updated blocks using the update block manager 108, and erased blocks using the erased block manager 110.

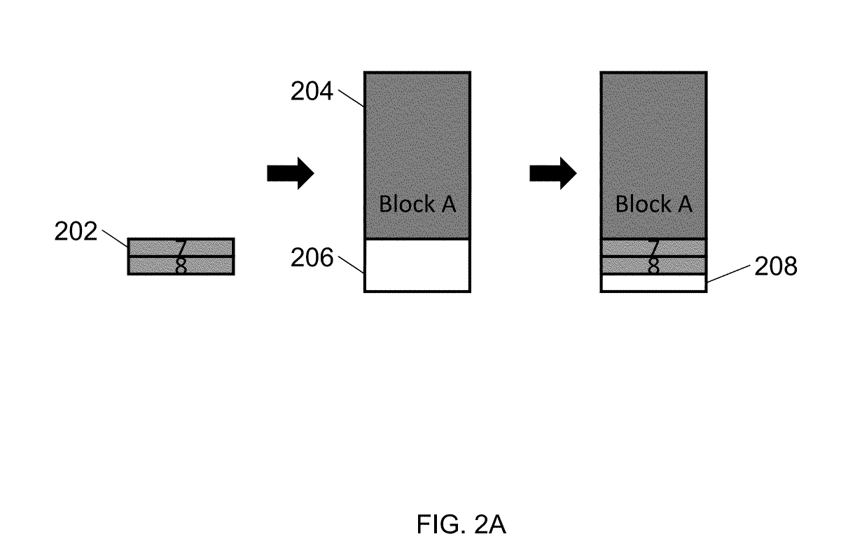

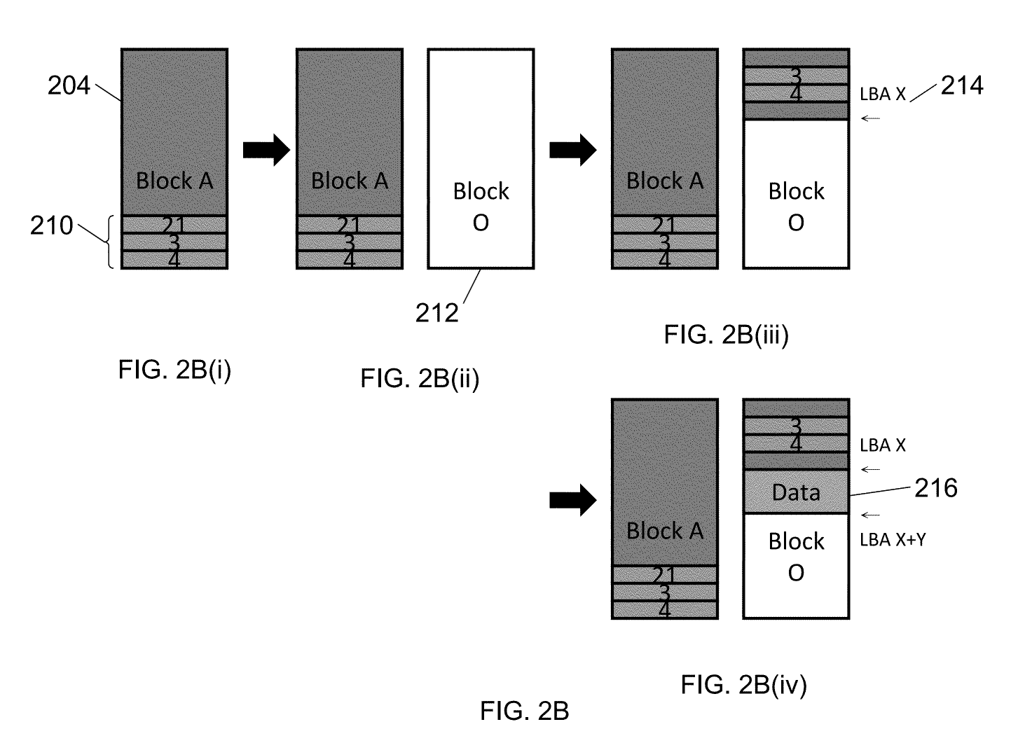

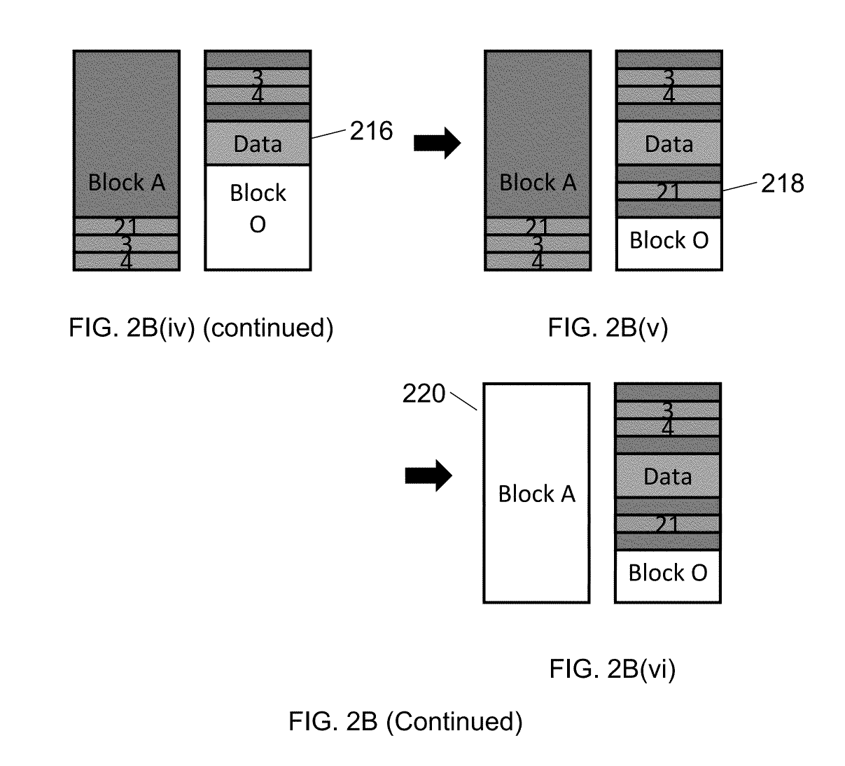

FIGS. 2A-2B illustrate a single-sector algorithm for writing data to logical blocks in accordance with some embodiments. FIGS. 2A-2B illustrate an operation whereby the host 104 requests a write operation to update existing data stored in a physical block A. In some flash memory systems, the flash memory system may improve on the block-based algorithm described above, to support faster write operations which do not require an erase operation for every program operation. Compared with the block-based algorithm which allocates a new physical block to hold updated data and erases the current block on every write operation from the host, the disclosed single-sector algorithm maintains information about the unused page size of every block, also referred to as a buffer area, or single-sector area. This is why the algorithm is named the single-sector algorithm.

FIG. 2A illustrates an example of writing an amount of data smaller than the unused page size of a physical block. FIG. 2A includes host data 202 to be written, Block A including an area 204 with existing data and a single-sector area 206, and an updated single-sector area 208. In the disclosed single-sector algorithm, if the host 104 (shown in FIG. 1) requests a write operation to write an amount of data smaller than the unused page size of a physical block, the memory controller may execute a program operation to write the data to the buffer area. As illustrated in FIG. 2A, the host 104 (shown in FIG. 1) requests to write data 202 to an LBA, illustrated by pages 7 and 8. Block A already has existing data 204, but has a single-sector area 206 available for writing additional data. After the write operation, Block A has been updated with the data 202, and the size of the single-sector area 208 has been reduced.

FIGS. 2B(i)-2B(iv) illustrate an example of writing data resulting in a new block in an “open” condition. FIGS. 2B(i)-2B(iv) include the area 204 in Block A with existing data, data 210 corresponding to offsets 21, 3, and 4, an unused block 212, a target LBA 214, and source data 216 requested by the host 104 (shown in FIG. 1) to be written to update existing data on Block A. The memory controller 102 (shown in FIG. 1) may maintain a limited number of blocks in an “open” condition. An open block refers to a block that has been programmed with partial data, and is available for storage of additional data. As illustrated in FIG. 2B(i), the host 104 (shown in FIG. 1) may request a write operation of source data 216 (shown in FIG. 2B(iv)) of length Y at an LBA X. In FIG. 2B(i), physical block A corresponding to logical block address X has an unused page size of zero for accepting new data, because existing data 204 and data 210 corresponding to offsets 21, 3, and 4 occupy the entirety of Block A including the single-sector area. In FIG. 2B(ii), as with the block-based algorithm described earlier, the memory controller 102 (shown in FIG. 1) gathers an unused block 212, illustrated by Block O. In FIG. 2B(iii), the memory controller 102 (shown in FIG. 1) writes to Block O the data intended to reside before the target LBA 214 requested by the host 104 (shown in FIG. 1), illustrated by LBA X. This includes existing data with offsets 3 and 4 from the single-sector area. In FIG. 2B(iv), the memory controller 102 (shown in FIG. 1) then writes the requested new source data 216 having length Y to block O using program operations for the flash memory. After writing the updated source data 216 to Block O, Block O may be considered an open block, because it has been programmed with data but is still available to accept new data in a subsequent write operation from the host 104 (shown in FIG. 1).

The number of open blocks may be limited in the system because tracking information related to open blocks uses resources on the flash memory. For example, resources are needed to track unused page sizes in open blocks, and which blocks are open. To improve performance, the flash memory may limit the number of open blocks at a time. In one embodiment, the single-sector algorithm keeps open at most one block.

FIGS. 2B(v)-2B(vi) illustrate an example of writing data resulting in the physical block being in a “closed” condition. FIGS. 2B(v)-2B(vi) include the updated source data 216 requested by the host 104 (shown in FIG. 1) to be written, existing data 218 including the data at offset 21, and a newly closed block 220. A closed block generally is not available for storage of additional data. Because of the restraints in the architecture of flash memory, the process of closing a block takes significantly longer than the process of opening a block. This is because, to close a block, the remaining unmodified data in the block is copied to the new block, and the original block is erased. Because of the flash memory architecture, erasing a block takes significantly longer than programming data to a block.

As illustrated in FIG. 2B(v)-2B(vi), if the memory controller 102 (shown in FIG. 1) writes to a different physical block, or if the write data area overlaps the written area, according to the single-sector algorithm the memory controller 102 (shown in FIG. 1) may close a block. In FIG. 2B(v), after the updated source data 216 from the host 104 (shown in FIG. 1) has been written to the new Block O, the remaining LBA data from Block A may be programmed, or written, to the new Block O. This includes the data 218 intended to reside at offset 21. In FIG. 2B(vi), the memory controller 102 (shown in FIG. 1) may update the logical-to-physical lookup table to point to Block O, and execute an erase operation on block A. The result is that Block A is now considered to be a closed block. As described earlier, it is desirable to reduce the number of close operations on blocks because due to flash memory architecture, erasing a block takes significantly longer than programming data to a block.

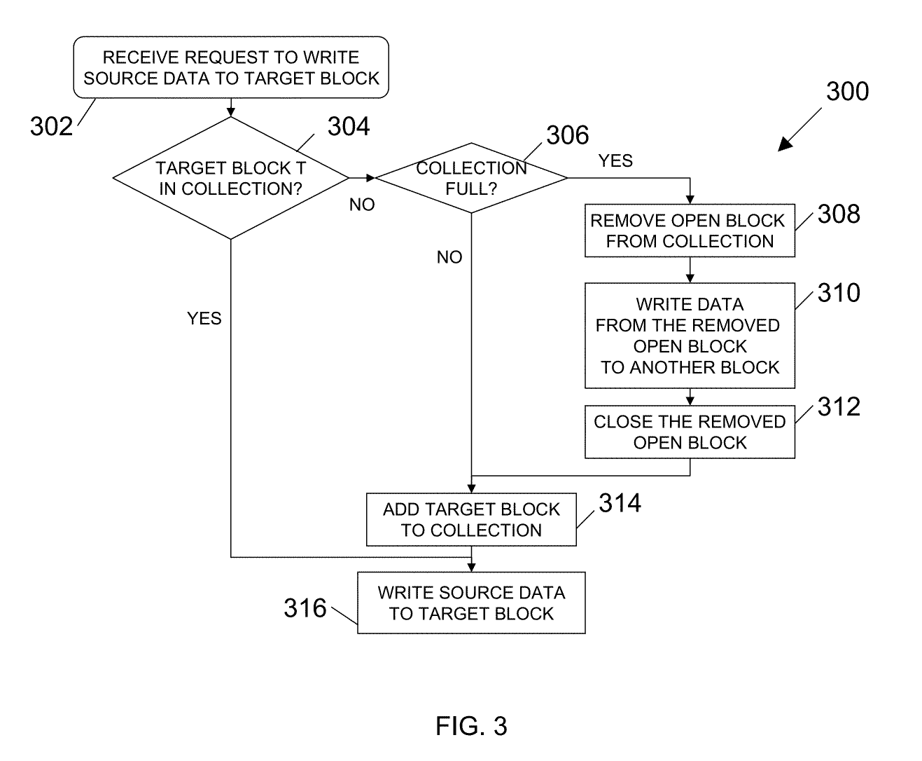

FIG. 3 illustrates a flow diagram of a multi-section method 300 for reducing close operations on open blocks when writing data to a flash memory in accordance with some embodiments. FIG. 3 includes the following steps: step 302 of receiving a request to write source data to a target block T; step 304 of determining whether the target block T is one of the open blocks; step 306 of determining whether a collection of open blocks is full; step 308 of removing an identifier representing an open block from the collection; step 310 of writing the data associated with the removed open block to another block; step 312 of closing the removed open block; step 314 of adding the target block T to the collection of open blocks; and step 316 of writing the source data to the target block T.

In step 302, the memory controller receives a request to write source data S to a target block T. In step 304, the memory controller determines whether the target block T is one of the open blocks. In some embodiments, the memory controller determines this information by determining if the target block T is listed in a collection of open blocks. The collection of open blocks includes a list of blocks that are currently open. In some aspects, the collection of open blocks can be implemented using a queue. If the target block T is one of the open blocks, the memory controller proceeds to step 316; if the target block T is not one of the open blocks, the memory controller proceeds to step 306.

In step 306, the memory controller determines if the collection of open blocks is full. The collection of open blocks is full if the collection maintains a list of predetermined number of open blocks. As discussed above, in some embodiments, the collection of open blocks can be implemented using a queue. In this case, the queue is full if each of the slots in the queue is associated with an open block. If the collection of open blocks is full, then the memory controller proceeds to steps 308-312 to close one of the open blocks; if the collection of open blocks is closed, then the memory controller proceeds to step 314.

In steps 308, the memory controller selects one of the open blocks from the collection and removes the selected open block from the collection of open blocks. In some embodiments, the memory controller can select the open block based on how long the open block has been in the collection. For example, the memory controller can select the open block that has been in the collection for the longest period of time. In another example, the memory controller can select the open block that has been in the collection for the shortest period of time. In other embodiments, the memory controller can select the open block randomly from the collection.

In step 310, once the memory controller removes the selected open block, the memory controller can select a second open block in the collection and write data from the removed open block into the second open block. In some embodiments, the memory controller can select the second open block based on how long the open block has been in the collection. For example, the memory controller can select, as the second open block, the open block that has been in the collection for the shortest period of time. In other embodiments, the second open block can be randomly selected from the collection.

In step 312, the memory controller can close the removed open block. To this end, the memory controller can update the logical-to-physical address table 106 so that the logical address previously associated with the removed open block can be newly associated with the second open block.

In step 314, the memory controller can add the target block into the collection of open blocks, indicating that the target block is now open. In step 316, the memory controller writes the received source data into the target block.

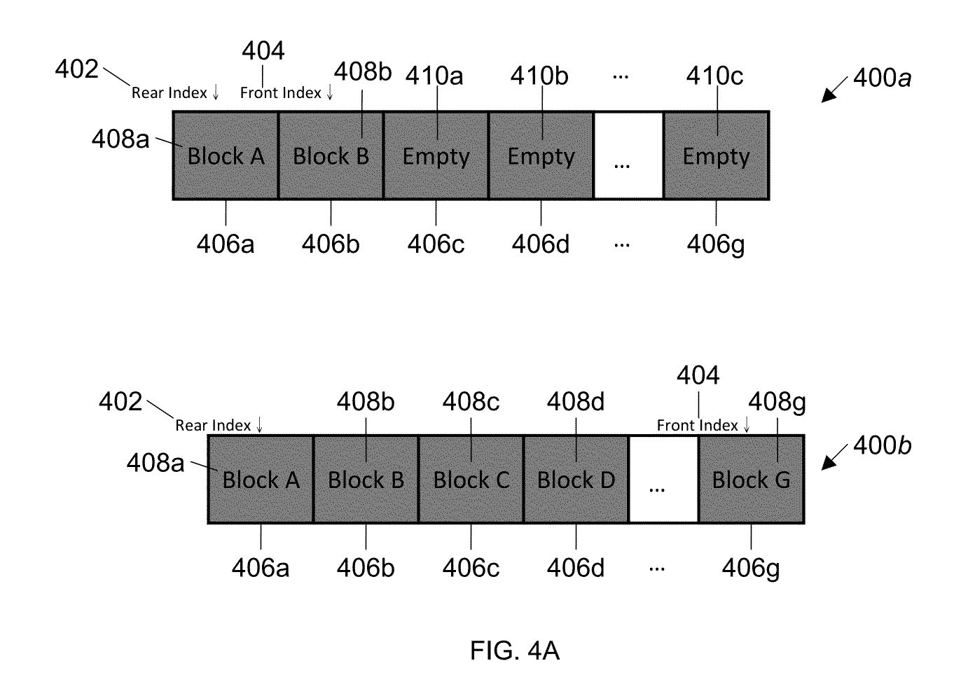

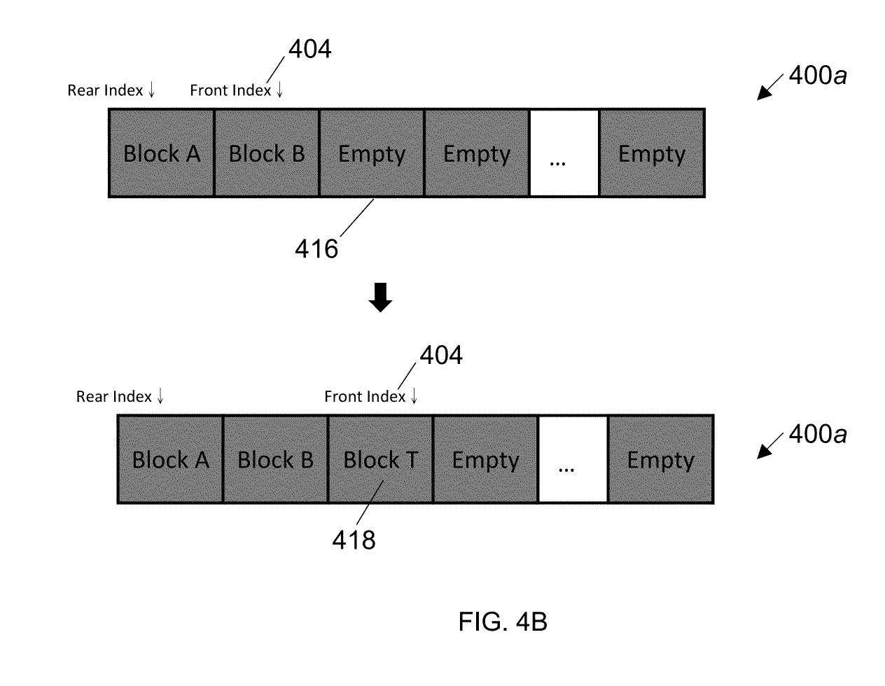

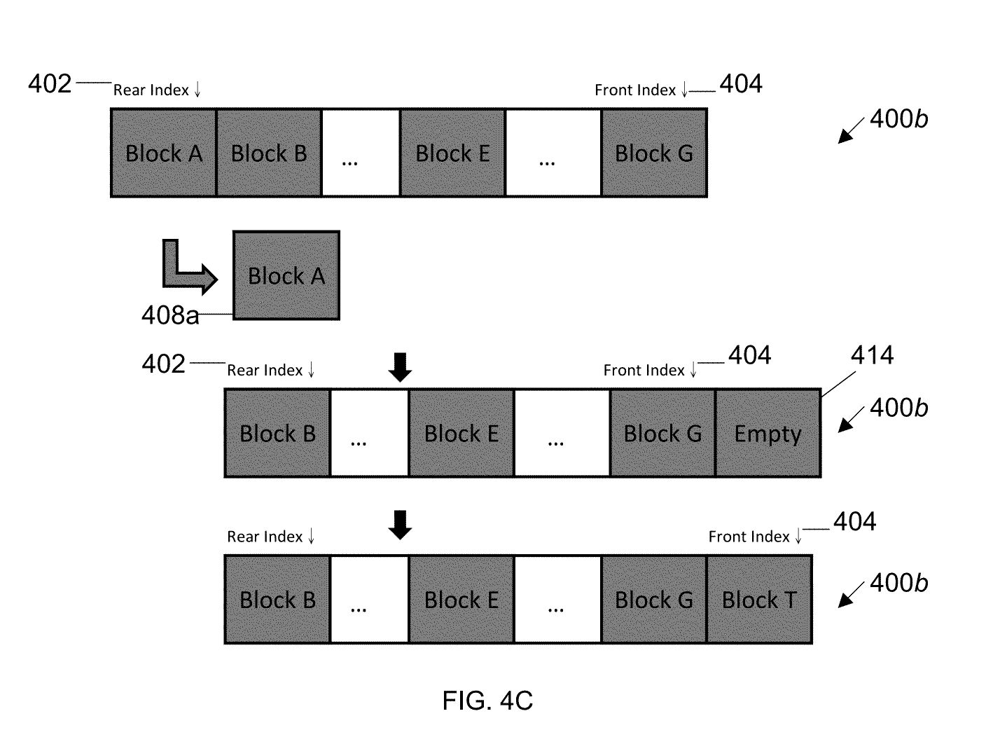

FIGS. 4A-4C illustrate block diagrams of a system and multi-section method of reducing close operations on open blocks when writing data to a flash memory in accordance with some embodiments. As illustrated in FIG. 3, the present system uses a collection to track open blocks which can accept source data from the flash memory controller 102 (shown in FIG. 1) to be stored. As discussed above, in one embodiment, the collection is a queue to track open blocks. The queue can include a plurality of slots, where each of the slots is configured to indicate an open block. The queue can maintain a list of open blocks and, based on a First-In-First-Out system when blocks need to be closed, the first block to be closed is the block referenced by the rear index. In some embodiments, the queue can identify an open block using an identifier. In one aspect, the identifier can be a memory address of the open block. A queue is a programming data structure in which the identifiers in the collection are kept in order, and the principal operations on the queue are the addition of identifiers to a front index and removal of identifiers from a rear index. This makes the queue a First-In-First-Out (FIFO) data structure. In a FIFO data structure, the first identifier added to the data structure will be the first one to be removed. This is equivalent to the requirement that once an identifier is added, all identifiers that were added before have to be removed before the new identifier can be retrieved. In other embodiments, the collection may be a stack, which is a Last-In-First-Out (LIFO) data structure. The addition operation may also be referred to as enqueuing or pushing. The removal operation may also be referred to as dequeuing or popping.

FIG. 4A illustrates block diagrams of example queues of open blocks in accordance with some embodiments. FIG. 4A includes queues 400a and 400b, a rear index 402 and a front index 404, a plurality of slots 406a-406g in the queues, and open block identifiers 408a-408g in the plurality of slots 406a-406g. Queue 400a represents a partially-filled queue of open blocks. In the partially-filled queue of open blocks, only a portion of the plurality of slots is associated with an open block identifier. Queue 400b represents a full queue of open blocks. In the full queue of open blocks, each of the plurality of slots is associated with an open block identifier.

Queue 400a has a rear index 402, representing that the first open block to be inserted into queue 400a was Block A. Accordingly, Block A will be the first open block to be removed from the queue 400a on the next removal operation. Queue 400a has a front index 404, representing that the most recently added open block was Block B. Queue 400a also has a plurality of empty slots 410a-410c, representing that queue 400a is not yet full. In contrast, queue 400b is full and cannot track any additional open blocks. Queue 400b is considered full because additional open blocks, referring to Block E and Block G, have been added to the queue, and there are no empty slots available to add additional open blocks. Rear index 402 continues to mark Block A, indicating that Block A will be the first block to be removed upon the next removal operation. Front index 404 marks Block G, indicating that Block G was the open block added most recently to the queue, and thus will be the last open block to be removed from the queue. In some embodiments, the number of slots in a queue can range from about five to about one hundred.

FIG. 4B illustrates a block diagram of the present system and method of reducing close operations on open blocks when the open-blocks queue is partially full in accordance with certain embodiments. FIG. 4B includes the queue 400a, the front index 404, and an empty slot 416. The memory controller 102 (shown in FIG. 1) receives a command from a host 104 (shown in FIG. 1) to write source data S to a target block T. As illustrated in FIG. 3, in step 306 the present method 300 determines whether the queue is full. As described above, queue 400a is not full, and so the method 300 proceeds to step 314, in which the memory controller 102 (shown in FIG. 1) adds the target block identifier 418 to the queue 400a, and in step 316, the memory controller 102 (shown in FIG. 1) opens target block T and writes the originally requested source data S to the target block T. The result of this addition is that the front index 404 is advanced to the slot 416 tracking the target block identifier 418. Advantageously, in this operation, the flash memory controller 102 (shown in FIG. 1) writes the source data S to the target block T, but the block is kept open without a close operation required from the flash memory controller 102 (shown in FIG. 1). As described above, although the memory controller 102 (shown in FIG. 1) could close the target block T, this would result in an erase operation that is long in time compared to keeping the block open.

FIG. 4C illustrates a block diagram of the present system and method of reducing close operations on open blocks when the open-blocks queue is full in accordance with some embodiments. FIG. 4C includes the queue 400b, the rear index 402 and the front index 404, the open block, and an empty slot 414. Similar to FIG. 4B, the memory controller 102 (shown in FIG. 1) receives a command from a host 104 (shown in FIG. 1) to write source data S to a target block T. As illustrated in FIG. 3, in step 306 the present method 300 determines whether the queue is full. As described above, queue 400b is full, and so the method 300 proceeds to step 308 of removing open block, Block A 408a, from queue 400b. In step 310, the memory controller 102 (shown in FIG. 1) retrieves the data associated with Block A 408a and writes the data to flash memory. Subsequently, in step 312, the memory controller 102 (shown in FIG. 1) closes Block A 408a. The result of these steps is that the memory controller 102 (shown in FIG. 1) marks the queue slot previously associated with Block A as an empty slot 414, and advances the rear index 402 so that rear index 402 now points to Block B as the next open block that will be removed from the queue on the next removal operation.

In step 314, the memory controller 102 (shown in FIG. 1) adds the target block identifier to the queue 400b, and in step 312, the memory controller 102 (shown in FIG. 1) opens target block T and writes the originally requested source data S to the target block T. The result of this addition is that the front index 404 is advanced to slot 414 tracking that the target block T is the open block most recently added to the queue 400b. One aspect of the present system and method is that, upon a write request from a host 104 (shown in FIG. 1), two different logical blocks may be read or written by the memory controller 102 (shown in FIG. 1): (1) the requested source data S is written to the requested target block T, and (2) an open block removed from the queue may have its data written to the flash memory, even if this second operation is not requested by the host.

Therefore, the present system and method reduce the number of required close operations from the flash memory controller 102 (shown in FIG. 1) by deferring the closing of blocks until the queue of open blocks becomes full.

With the general method now described, the following paragraphs present details on various applications of the present system and method. It should be noted that these details are merely examples. The present disclosure is useful in situations requiring the host to write data frequently to many different logical blocks. One such situation may arise when a flash memory is used with various file systems.

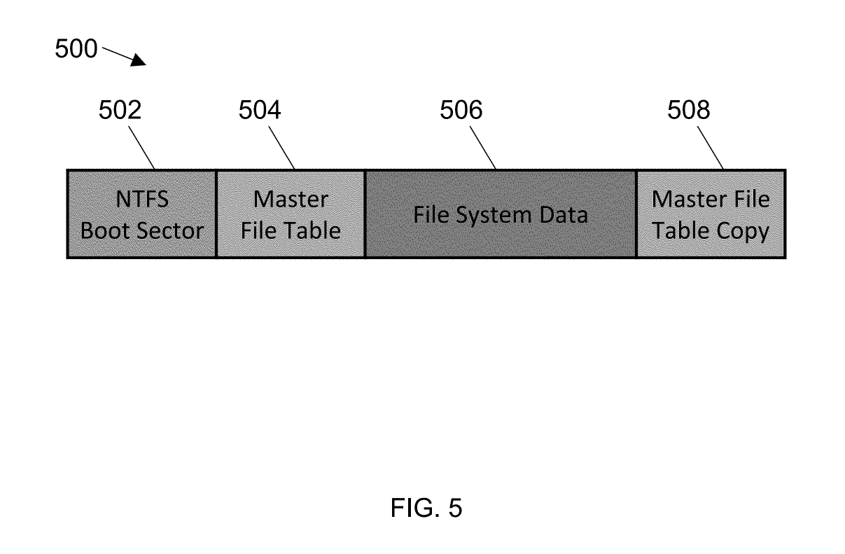

FIG. 5 illustrates an NTFS file system 500 in accordance with some embodiments. FIG. 5 includes a boot sector 502, a master file table 504, a file system data volume 506, and a copy or mirror 508 of the master file table. The MICROSOFT® New Technology File System (NTFS) is widely used in modern Windows operating systems. An operating system is software running on a computer that manages computer hardware resources and provides common services for running various software programs. The boot sector 502 contains information sufficient to boot an operating system installed on the file system 500. The master file table (MFT) 504 contains metadata describing files stored on the file system data volume 506. The metadata may include data describing the file data, such as file names, timestamps, stream names, and lists of cluster numbers where data streams reside, indices, security identifiers, and file attributes such as “read only,” “compressed,” or “encrypted.” The MFT copy 508 or mirror may include copies of metadata or records essential for journaling or recovery of the file system. For each piece of file data that is written by the host to the file system data volume 506, the interaction of the file system data volume 506 is such that the host may write many different blocks to the storage medium, representing at least additional entries in the MFT 504 and in the MFT mirror 508.

As illustrated in FIG. 5, because of the nature of the NTFS file system 500, these attributes of NTFS mean that a host and flash memory supporting the NTFS file system 500 may write data frequently to many different logical blocks, corresponding to different locations on the NTFS file system 500, such as the MFT 504, the file system data volume 506, and the MFT mirror 508. Advantageously, the present system and method may improve performance by reducing the number of close block operations required for these frequent write operations to many different logical blocks.

Additional file systems which may require a host and flash memory controller to write frequently to many logical blocks may include file systems for the UNIX® or LINUX® family of operating systems, such as second extended file system (ext2), third extended file system (ext3), fourth extended file system (ext4), or any file system using the file metadata referred to as inodes, which may require frequent write operations to many different logical blocks.

There are many alternatives that can be used with these embodiments. For example, the flash memory discussed in the foregoing examples may include NOR flash memory and NAND flash memory such as solid state drives. The memory controller may divide the flash memory into multiple sections, and may associate a collection with each section.

Those of skill in the art would appreciate that the various illustrations in the specification and drawings described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (for example, arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

The terms “SSD”, “SSD device”, and “SSD drive” as used herein are meant to apply to various configurations of solid state drive devices equipped with SSD controllers and isolation devices in accordance with one or more of the various embodiments of the disclosed subject matter. It will be understood that other types of non-volatile mass storage devices in addition to flash memory devices may also be utilized for mass storage.

We claim:

1. A method for reducing a number of close operations in a flash memory, comprising:
maintaining a queue having a plurality of slots, wherein each of the plurality of slots is configured to maintain an identifier of an open block in the flash memory;
receiving a request to write data to a target block, wherein the target block is one of a plurality of blocks in the flash memory;
determining if the queue includes an identifier of the target block;
if the queue includes an identifier of the target block, storing the data at the target block of the flash memory;
if the queue does not include the identifier of the target block:
determining if each of the plurality of slots in the queue is associated with an open block, and if so, removing an identifier of one of the open blocks from the queue;
adding the identifier of the target block to the queue; and
storing the data at the target block of the flash memory.

2. The method of claim 1, wherein the identifier comprises a memory address.

3. The method of claim 1, further comprising maintaining a rear index and a front index for the queue, wherein the rear index references to a first slot and the front index references to a second slot, wherein the first slot is associated with the first open block to be removed from the queue, and wherein the second slot is associated with the last open block to be removed from the queue.

4. The method of claim 3, wherein removing the identifier of one of the open blocks from the queue comprises removing an identifier of the first open block in the first slot and modifying the rear index to reference a new first open block to be removed from the queue.

5. The method of claim 1, further comprising storing data of the one of the open blocks at another block in the flash memory.

6. The method of claim 5, further comprising, in response to storing the data of the one of the open blocks at another block in the flash memory, erasing the data in the one of the open blocks.

7. The method of claim 1, wherein the flash memory is configured with a New Technology File System (NTFS) file system.

8. A memory system comprising:
a flash memory comprising a plurality of blocks, wherein each block is configured to store data; and
a flash memory controller configured to maintain a queue having a plurality of slots, wherein each of the plurality of slots is configured to maintain an identifier of an open block in the flash memory, to store data to a target block in the flash memory, to remove an identifier of one of the open blocks from the queue, and to add an identifier of the target block to the queue.

9. The system of claim 8, wherein the identifier comprises a memory address.

10. The system of claim 8, wherein the controller is configured to maintain a rear index and a front index for the queue, wherein the rear index references to a first slot and the front index references to a second slot, wherein the first slot is associated with the first open block to be removed from the queue, and wherein the second slot is associated with the last open block to be removed from the queue.

11. The system of claim 10, wherein the controller is further configured to remove an identifier of the first open block from the first slot and to modify the rear index to reference a new first open block to be removed from the queue.

12. The system of claim 8, wherein the controller is configured to store data in the one of the open blocks at another block in the flash memory.

13. The system of claim 12, wherein the controller is configured to erase the data in the one of the open blocks.

14. The system of claim 8, wherein the flash memory is configured with a New Technology File System (NTFS) file system.

15. The system of claim 8, wherein the flash memory is configured with a second extended file system (ext2), a third extended file system (ext3), or a fourth extended file system (ext4).

16. A non-transitory computer program product, tangibly embodied in a computer-readable medium, the computer program product including instructions operable to cause a data processing apparatus to:
maintain a queue having a plurality of slots, wherein each of the plurality of slots is configured to maintain an identifier of an open block in the flash memory;
receive a request to write data to a target block, wherein the target block is one of a plurality of blocks in the flash memory;
determine if the queue includes an identifier of the target block;
if the queue includes the identifier of the target block, store the data at the target block of the flash memory;
if the queue does not include the identifier of the target block:
determine if each of the plurality of slots in the queue is associated with an open block, and if so, remove an identifier of one of the open blocks from the queue;
add the identifier of the target block to the queue; and
store the data at the target block of the flash memory.

17. The computer program product of claim 16, wherein the identifier comprises a memory address.

18. The computer program product of claim 16, further comprising instructions operable to cause the data processing apparatus to maintain a rear index and a front index for the queue, wherein the rear index references to a first slot and the front index references to a second slot, wherein the first slot is associated with the first open block to be removed from the queue, and wherein the second slot is associated with the last open block to be removed from the queue.

19. The computer program product of claim 16, wherein instructions operable to cause the data processing apparatus to remove the identifier of one of the open blocks from the queue comprises instructions operable to cause the data processing apparatus to remove an identifier of the first open block in the first slot and to modify the rear index to reference a new first open block to be removed from the queue.

20. The computer program product of claim 19, further comprising instructions operable to cause the data processing apparatus to erase data in the first open block.
